(19) United States
(12) Patent Application Publication
(10) Pub. No.: US 2019/0246614 A1
(43) Pub. Date: Aug. 15, 2019

(54) WEARABLE DEVICE FOR MEASURING LOBSTERS

(71) Applicant: Raymond Joseph HEALY, JR., Homestead, FL (US)

(72) Inventor: Raymond Joseph HEALY, JR., Homestead, FL (US)

(21) Appl. No.: 16/276,078

(22) Filed: Feb. 14, 2019

Related U.S. Application Data
(60) Provisional application No. 62/630,466, filed on Feb. 14, 2018.

(51) Int. Cl. A01K 97/00; G01B 5/02; G01B 1/00; A45F 5/00

(52) U.S. Cl. CPC A01K 97/00; G01B 5/02; A45F 2005/002; A45F 5/00; A45F 2005/008; G01B 1/00

(57) ABSTRACT

A wearable device for measuring lobsters includes a metal band encapsulated within a flexible coating to form an elongated body, and a slot defined within the elongated body by a first corner and a spaced apart second corner along a bottom side of the elongated body. The first corner and the second corner extend inwards from the bottom side and into the elongated body, and the first corner and the second corner are spaced apart from each other a distance corresponding to a pre-determined length of a carapace of a lobster. In addition, a cross section of the metal band switches from convex to concave upon changing from a flat position to a curled position when slapped across a wrist or other object.

### CROSS-REFERENCE TO RELATED APPLICATIONS

This application claims priority to U.S. Provisional Application Ser. No. 62/630,466 filed on Feb. 14, 2018 the contents of which are herein incorporated by reference in their entirety.

### TECHNICAL FIELD

The present invention relates to the field of fishing, and, more particularly, to a wearable device for measuring lobsters.

### BACKGROUND

As is well known, lobsters are highly desirable for eating and are a prime target for scuba divers and the like. However, the taking of lobsters less than a specified size is ecologically unsound and is often illegal. Consequently, it is necessary for divers to measure the lobsters to be certain that the catch is legal.

Lobster measuring devices currently are flat pieces of plastic or metal, such as aluminum or stainless steel, formed to indicate the minimum legal length. When the diver locates a lobster, the diver catches and holds the lobster with one hand, grasps the measuring device with the other hand and holds the measuring device against the lobster to measure its length.

Often time the measuring devices are misplaced and it is difficult for the diver to search for the lost measuring device while in the water holding a live lobster in one hand.

### SUMMARY

In view of the foregoing background, it is therefore an object of the present invention to provide a wearable device for measuring lobsters. The device includes a metal band encapsulated within a flexible coating to form an elongated body, and a slot is formed into the elongated body by a first corner and a spaced apart second corner along a bottom side of the elongated body. The first corner and the second corner extend inwards from the bottom side and into the elongated body, and the first corner and the second corner are spaced apart from each other a distance corresponding to a pre-determined length of a carapace of a lobster. In addition, a cross section of the metal band switches from convex to concave upon changing from a flat position to a curled position when slapped across a wrist or other object.

### BRIEF DESCRIPTION OF THE DRAWINGS

FIG. 1 is a front elevational view of a wearable device for measuring lobsters in a flat position in accordance with a particular embodiment of the present invention;

FIG. 2 is a perspective view of the wearable device of FIG. 1 in a curled position on a wrist of a person;

FIG. 3 is a perspective top view of the wearable device in the curled position;

FIG. 4 is a cross sectional view taken in the direction of line 4-4 of FIG. 1;

FIG. 5 is a front elevational view having a partial cut away section;

FIG. 6a is a cross sectional view taken in the direction of line 6-6 of FIG. 5 when the device is in the flat position;

FIG. 6b is a cross sectional view when the cross section of FIG. 6a when the device is in the curled position; and

FIG. 7 is a front elevational view of another particular aspect of the present invention having a partial cut away section.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The present invention will be discussed in the context of measuring a lobster, such as a Florida spiny lobster. Those of skill in the art will appreciate additional embodiments and aspects of the present invention may be adapted to measure other aquatic animals or other creatures that may not be aquatic. For example, without limitation, additional embodiments and aspects of the present invention may be used to measure other types of lobsters, various species of fish, crabs, crustaceans, or other creatures that may be hunted or fished.

Referring now to FIG. 1, a particular illustrative embodiment of a wearable device for measuring lobsters is disclosed. The device 100 includes an elongated body 102, having a first end 104 and an opposing second end 106. A slot 108 is formed into the elongated body by a first corner 110 and a spaced apart second corner 112 along a bottom side 114 of the elongated body 102. The first corner 110 and the second corner 112 extend inwards from the bottom side 114 and into the elongated body 102 a distance “y”. The preferred dimensions for the device 100 are about twenty-eight and a half (28.5) centimeters in length “L” and about three centimeters wide “W”.

The first corner 110 and the second corner 112 are spaced apart from each other a distance “x”. The length “x” of the slot 108 may correspond to a legal catch size of a carapace of a lobster.

For example, in Florida the minimum length of the carapace is 3 inches to be a legal catch. Accordingly, the slot 108 has a length of 3 inches. In use, the first corner 110 (or the second corner) is placed on the front of the carapace of the lobster in between the eyes. If the carapace extends past the second corner 112, that indicates the carapace is at least, or greater, than 3 inches and that the lobster is legal to keep.

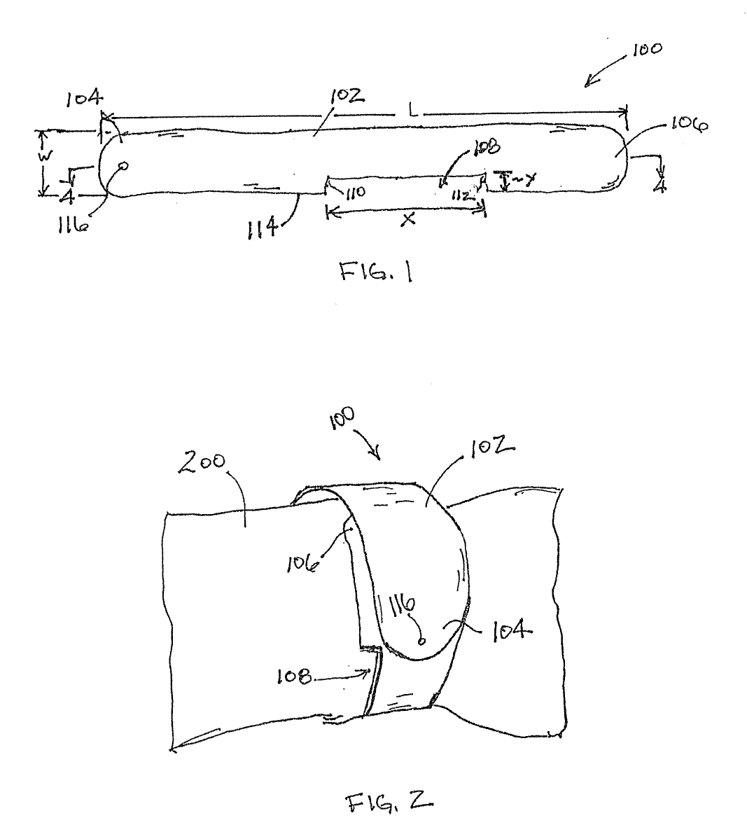

The wearable device 100 is shown in a curled position on a wrist 200 of a person in FIG. 2. The device 100 is able to switch from the flat position shown in FIG. 1 to the curled position shown in FIG. 2 because it is a bistable structure such as a bistable spring band. In other words, the device 100 has two stable mechanical shapes, namely, a flat shape and a curled shape. Thus, when the device 100 is in its flat position and is slapped across the wrist 200, the device 100 curls around the wrist 200 and stays secure in the curled position (i.e., circular shape). The wearable device 100 may also have an aperture 116 proximate to one end that can be used to hang the wearable device 100 on a hook, for example.

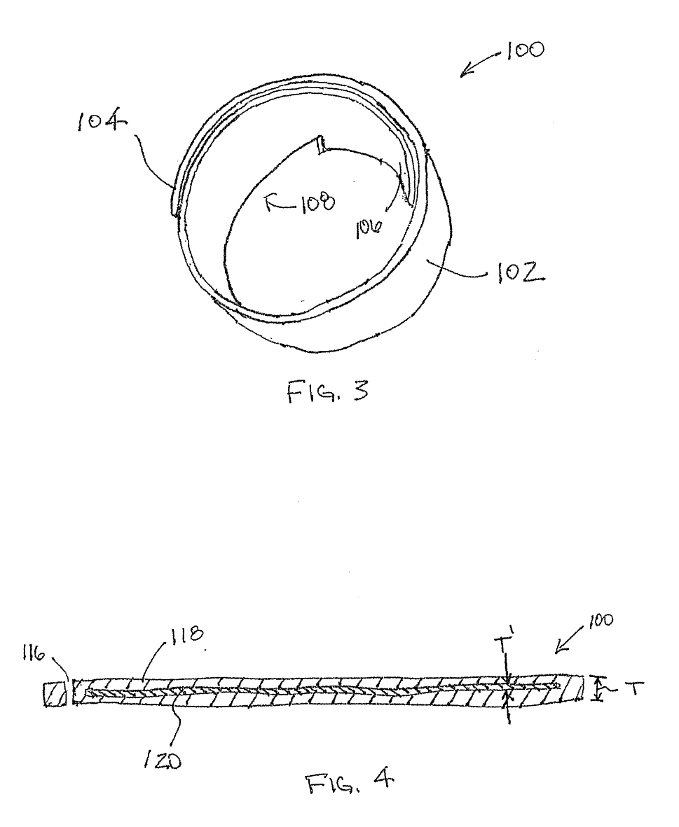

As shown in FIG. 3, when the device 100 is in the curled position the second end 106 lays directly against the wrist 200 and the first end 104 overlaps the elongated body 102.

Referring now to FIG. 4, a cross section of the device 100 is shown. The thickness of the device 100 is exaggerated for clarity. In particular, the device 100 includes a metal band 120 sandwiched and encapsulated within a flexible coating 118 such as silicone, for example. The cross section of the metal band 120 switches from convex to concave upon changing from the flat position to the curled position. The overall thickness “T” of the device 100 is about 2.16 millimeters and a thickness “T′” of the metal band 120 is about 0.16 millimeters. The thickness and width of the metal band 120 is required in order for it to perform as a bistable metal spring that can be easily wrapped around a wrist or other object.

The metal band 120 is encased by the flexible coating 118 and has a constant width except at the location of the slot 108 in a particular embodiment. As can be seen in FIG. 5, the width of the metal band 120 narrows where the slot 108 is located and has a similar shape to that of the slot 108. However, the notch does not extend more than half way through a width of the metal band 120 in order for the metal band 120 to retain its properties as a bistable spring. The preferred width “W′” of the metal band 120 is about 2.2 centimeters and the length “L′” of the metal band 120 is about 28 centimeters.

As explained above, the cross section of the metal band 120 has a convex shape as shown in FIG. 6a when in the flat position, and switches to the concave shape as shown in FIG. 6b in the curled position when slapped over the wrist 200 or other object.

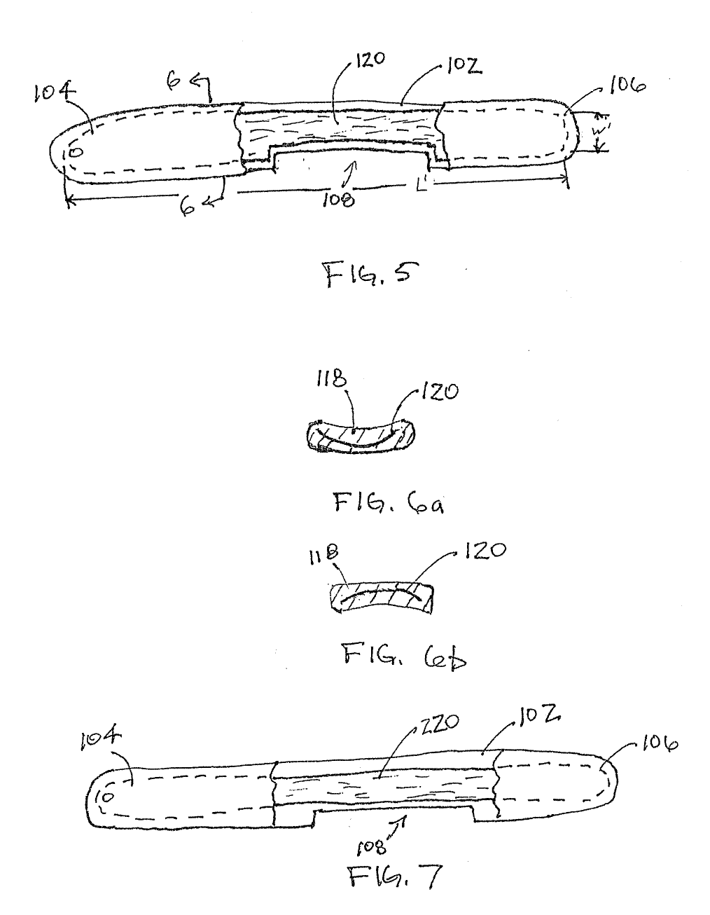

FIG. 7 is another aspect of the present invention, in particular where the metal band 220 has a constant width along its length and does not have a notch as in FIG. 5. Instead, the slot 108 is parallel to the metal band 220. The metal band 220 is similar to metal band 120 described above in that it is bistable spring and has a convex shape when in the flat position, and switches to the concave shape in the curled position when slapped over the wrist 200.

Accordingly, the measuring device 100 is always readily accessible to the diver to measure a lobster in the water.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A wearable device for measuring lobsters, the device comprising:
a metal band;
a flexible coating encasing the metal band to define an elongated body; and
a slot defined within the elongated body having a length corresponding to a legal catch size of a lobster.

2. The wearable device of claim 1, wherein a cross section of the metal band switches from convex to concave upon changing from a flat position to a curled position when slapped across a wrist or other object.

3. The wearable device of claim 1, wherein the flexible coating comprises silicone.

4. The wearable device of claim 1, wherein the length of the slot being a minimum length of a carapace of a lobster to be the legal catch size.

5. The wearable device of claim 1, wherein the slot comprises a first corner and a spaced apart second corner along a bottom side of the elongated body, the first corner and the second corner extend inwards from the bottom side and into the elongated body, and the first corner and the second corner are spaced apart from each other by the length corresponding to the legal catch size of the lobster.

6. The wearable device of claim 1, wherein the metal band comprises a bistable spring band.

7. The wearable device of claim 1, wherein the slot extends into the metal band.

8. The wearable device of claim 1, wherein the slot is defined within the flexible coating and parallel to the metal band.

9. The wearable device of claim 1, wherein the length of the slot is about three inches.

10. A wearable device for measuring lobsters, the device comprising:
a metal band comprising a bistable spring band; and
a slot defined within the elongated body having a length corresponding to a legal catch size of a lobster.

11. The wearable device of claim 10, further comprising a flexible coating encasing the metal band to define an elongated body.

12. The wearable device of claim 10, wherein a cross section of the metal band switches from convex to concave upon changing from a flat position to a curled position when slapped across a wrist or other object.

13. The wearable device of claim 11, wherein the flexible coating comprises silicone.

14. The wearable device of claim 10, wherein the length of the slot being a minimum length of a carapace of a lobster to be the legal catch size.

15. The wearable device of claim 10, wherein the slot comprises a first corner and a spaced apart second corner along a bottom side of the metal band defining the length corresponding to the legal catch size of the lobster.

16. The wearable device of claim 10, wherein the length of the slot is about three inches.

17. A wearable device for measuring lobsters, the device comprising:
a bistable spring band;
a flexible coating encasing the bistable spring band to define an elongated body; and
a slot having a first corner and a spaced apart second corner along a bottom side of the elongated body, the first corner and the second corner extending inwards from the bottom side and into the elongated body.

18. The wearable device of claim 17, wherein a cross section of the bistable spring band switches from convex to concave upon changing from a flat position to a curled position when slapped across a wrist or other object.

19. The wearable device of claim 18, wherein the flexible coating comprises silicone.

20. The wearable device of claim 19, wherein the length of the slot being a minimum length of a carapace of a lobster to be the legal catch size.
